(19) United States
(12) Patent Application Publication
(10) Pub. No.: US 2023/0409403 A1
(43) Pub. Date: Dec. 21, 2023

(54) CONTROL DEVICE AND CONTROL METHOD

(71) Applicant: Hitachi Astemo, Ltd., Hitachinaka-shi, Ibaraki (JP)

(72) Inventors: Takahiro IIDA, Ibaraki (JP); Makoto IJUIN, Ibaraki (JP); Shin KAGOSHIMA, Ibaraki (JP)

(73) Assignee: Hitachi Astemo, Ltd., Hitachinaka-shi, Ibaraki (JP)

(21) Appl. No.: 18/037,581

(22) PCT Filed: Aug. 30, 2021
(86) PCT No.: PCT/JP2021/031775

§ 371 Date: May 18, 2023

(30) Foreign Application Priority Data
Feb. 24, 2021 (JP) 2021-027460

(51) Int. Cl. G06F 9/50; B60W 50/00

(52) U.S. Cl. CPC G06F 9/5038; B60W 50/00; B60W 2050/0005

(57) ABSTRACT

A control device includes a plurality of cores each having an array of one or more process portions that are started cyclically. The control device includes a first process portion having a given logical execution time set therefor, and a time monitoring unit that determines an execution state of each of the process portions in a determination time shorter than the logical execution time of the first process portion. The time monitoring unit determines whether a passage time from the start of the first process portion exceeds the determination time.

### INCORPORATION BY REFERENCE

This application claims priority to Japanese Patent Application No. 2021-27460 filed on Feb. 24, 2021, the contents of which are incorporated herein by reference.

### TECHNICAL FIELD

The present invention relates to an electronic control device, and particularly related to a technology for guaranteeing the improved performance and sound operation under a high-load condition of a multi-core processor when it runs software in parallel.

### BACKGROUND ART

Equipping processors with multiple cores has led to complicated software structures, which has given rise to a problem that conflict in data processing between simultaneously running multiple functions must be solved. Hence difficulty in software designing is increasing.

Conventionally, a technique of eliminating complexity by statically designed processing timing has been discussed. In time division scheduling, a process execution time of a processor is divided into time slots each having a certain time span, and process execution is switched time slot by time slot. To realize a concept like interruption, a method of defining high priority and a small time slot is employed.

A method of allocating logical execution times (LET) is also employed, in which case the process is divided into small units of LETs for input, calculations, output, and the like. For example, in the case of a process of LET=5 ms, even if the process ends before its LET runs out, an output process is not executed until 5 ms passes from the start of the process.

As background art in the technical field defined herein, the following conventional technique has been known. Patent Literature 1 (Japanese Patent Application Laid-Open No. H5-241906) discloses a programmable control device including: a main processor that executes application tasks under execution state monitoring by a watchdog timer function, the application tasks having an execution priority order and an execution time set for each application task; a scheduler that starts the application tasks at a given cycle according to their execution priority orders; an execution time monitoring unit that monitors an execution time of each application task and that determines whether the execution time has exceeded an execution time set for each application task or an execution cycle determined by a time width; and a priority order changing unit that according to a result of detection of excess over an execution time, lowers the execution priority order of an application task currently in execution to change the execution priority orders of the application tasks (see claim 1).

### SUMMARY OF INVENTION

### Technical Problem

According to the above-described conventional technique, maintaining real-time processing and ensuring easiness in designing can both be achieved. This technique, however, has difficulty in guaranteeing that the processing time is set as designed, which raises a possibility that a static processing time defined as a time slot or an LET cannot be observed in process execution. This brings a problem to clear that execution of a substitution process and operation must be ensured to maintain controllability even in the case of excess over a time limit.

According to Patent Literature 1 described above, each process has an execution time set therefor, and the execution time monitoring unit monitors the execution time of the process portion to determine whether its execution time has exceeded the set execution time and changes the process priority order. When a specific process becomes a high-load process, the priority order of the process is lowered so that the high-load process does not affect other processes. This keeps the overall processing cycle in tact.

However, in running control software, the order of execution of processes independent of each other or real-time processing of data may become important factors in some cases. For example, in a case where an instruction value process portion that calculates a control instruction value in terms of a physical value and an output process portion that outputs a control instruction value to drive equipment, such as a motor, operate independent of each other, if the priority order of the instruction value process portion is lowered, the output process portion becomes unable to acquire continuous values, which affects control performance, e.g., rendering motor control inefficient, in some cases.

According to the present invention, even when a processing time exceeds a designed processing time, a drop in controllability and safety is suppressed.

### Solution to Problem

A typical example of the present invention disclosed herein is as follows. A control device has a plurality of cores that execute a plurality of process portions that are started cyclically. The control device includes: a first process portion having a given logical execution time set therefor; and a time monitoring unit that determines an execution state of each of the process portions in a determination time shorter than the logical execution time of the first process portion. The time monitoring unit determines whether a passage time from the start of the first process portion exceeds the determination time.

### Advantageous Effects of Invention

According to one aspect of the present invention, in a multi-core processor that runs software in parallel, sound operations under a high-load condition can be ensured as real-time processing is maintained. Problems, configurations, and effects that are not described above will be made clear by the following description of embodiments.

### BRIEF DESCRIPTION OF DRAWINGS

FIG. 1 depicts a configuration of a control system according to an embodiment of the present invention.

FIG. 2 depicts a configuration of an in-vehicle control device that is an example of a control device 1 according to the embodiment.

FIG. 3 is a time chart showing an example of execution timing of software according to a first embodiment.

FIG. 4A is a time chart showing a case where a problem has occurred at a multi-core control system in which an LET is set.

FIG. 4B is a time chart showing a case where a problem has occurred at the multi-core control system in which an LET is set.

FIG. 5 is a time chart showing a case where another problem has occurred at the multi-core control system in which an LET is set.

FIG. 6 depicts an execution time monitoring method according to the first embodiment.

FIG. 7 depicts an execution time monitoring method according to a second embodiment.

FIG. 8 depicts an execution time monitoring method according to a third embodiment.

FIG. 9A depicts an execution time monitoring method according to a fourth embodiment.

FIG. 9B depicts the execution time monitoring method according to the fourth embodiment.

FIG. 10 depicts an execution time monitoring method according to a fifth embodiment.

FIG. 11A depicts an execution time monitoring method according to a sixth embodiment.

FIG. 11B depicts the execution time monitoring method according to the sixth embodiment.

FIG. 12A depicts an execution time monitoring method according to a seventh embodiment.

FIG. 12B depicts the execution time monitoring method according to the seventh embodiment.

FIG. 13 depicts a standby time selection table of an eighth embodiment.

### DESCRIPTION OF EMBODIMENTS

Embodiments of the present invention will hereinafter be described with reference to the drawings. In description of the embodiments, the same constituent elements and functions are denoted by the same reference signs and description thereof will be omitted.

### First Embodiment

In the first embodiment, a control device 1 includes a time monitoring unit 201, which allows a preventive measure by which when a certain process portion (1011) has becomes a high-load state, breach of a logical execution time (LET), which will be described later, by another process portion (1011) is prevented.

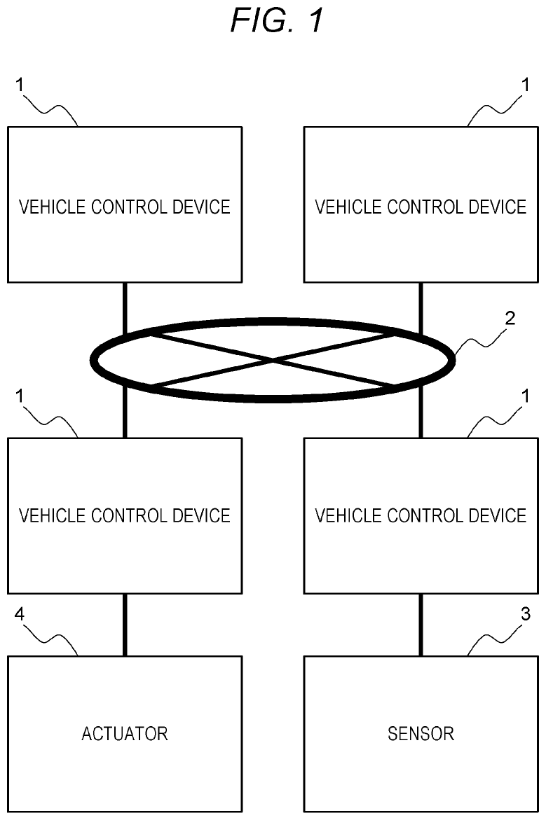

FIG. 1 depicts a configuration of a control system according to an embodiment of the present invention.

The control system includes a plurality of control devices 1, and a network 2 connects the control devices 1 to each other. For example, the control devices 1 are in-vehicle control devices connected by an in-vehicle network. The control devices 1 transmit communication data to the network 2, which allows the data to be exchanged between the control devices 1. Each control device 1 calculates a control instruction value, based on data acquired from the sensor 3, and creates an instruction to an actuator 4 and communication data to a different control device 1.

The network 2 transfers data, using Control Area Network (CAN), Ethernet, or other communication protocols. The network 2 is not always a wired communication network but may be a wireless communication network.

The sensor 3 is an angle sensor, a speed sensor, a pressure sensor that detects a brake pressure, etc., an external environment detector (e.g., camera, Ladar, Lidar, etc.), a switch, or the like. The sensor 3 sends information on the external environment, information based on human operations, or information on physical quantities applied to a vehicle, to the control device 1, as digital data or analog data.

The actuator 4 is any one of devices all operated by control signals, which include devices that control behavior of the vehicle, such as an engine, a motor, a brake, and an electromagnetic valve, devices that provide information to occupants and objects outside the vehicle, such as a car navigation system, a meter, a buzzer, and a lamp, operation devices, such as a brake pedal, an accelerator, and a steering wheel, and devices that keep the occupants safe, such as a seat belt and an airbag.

The control device 1 calculates a control instruction value, using input from the sensor 3 and communication data from a different control device 1, and transfers data to a different control device 1 and transmits the control instruction value to the actuator 4, thereby causing the vehicle to operate while providing an occupant with the vehicle's functions.

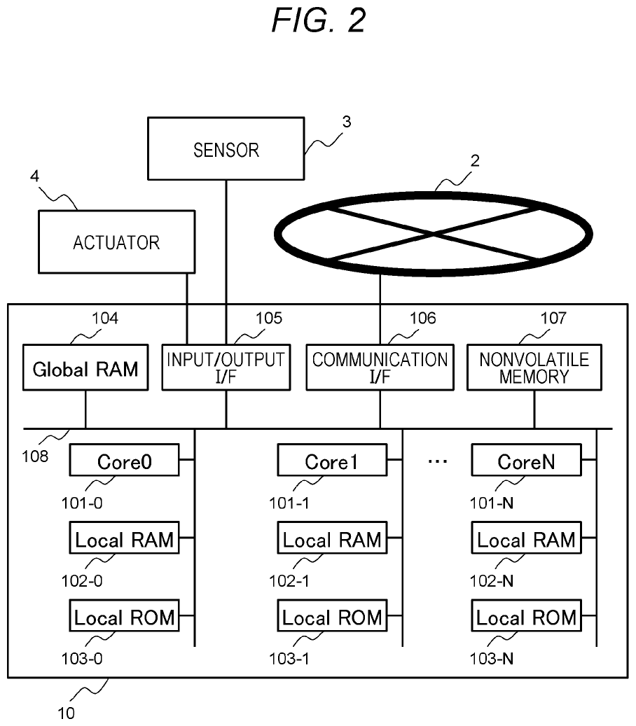

FIG. 2 depicts a configuration of an in-vehicle control device 10 that is an example of the control device 1.

The in-vehicle control device 10 includes a plurality of cores (101-0, 101-1, . . . 101-N) that execute software processing, a global RAM 104, an input/output IF 105, a communication IF 106, and a nonvolatile memory 107. These constituent elements are interconnected via a bus 108. Each core 101 is connected to 0 or more Local RAMs (102-0, 102-1, . . . , 102-N) and to 0 or more Local ROMs (103-0, 103-1, . . . , 103-N) via the bus 108. In the following description, subscripts to the cores, Local RAMs, and Local ROMs are omitted when distinguishing individual Local RAMs and Local ROMs from each other is unnecessary.

The Local RAM 102 stores data used at execution of software. The Local RAM 102 allows the core 101 directly connected thereto to make data access, i.e., data writing/reading to/from the Local RAM 102, and may also allow a different core 101 to data writing/reading to/from the Local RAM 102. The speed of data writing/reading by the different core 101 is lower than the same by the core 101 directly connected to the Local RAM 102.

The Local ROM 103 may store a program used at execution of software and may store data as well. The Local ROM 103 allows the core 101 connected thereto to make data access, i.e., data writing/reading to/from the Local ROM 103, and may also allow a different core 101 to data writing/reading to/from the Local ROM 103. The speed of data writing/reading by the different core 101 is lower than the same by the core 101 directly connected to the Local ROM 103.

The Global RAM 104 stores data used at execution of software. The Global RAM 104 allows all the cores 101 to make data access, i.e., data writing/reading to/from the Global RAM 104. Generally, the speed of data writing/reading to/from the Global RAM 104 is lower than the same of data writing/reading to/from the Local RAM 102. In addition, generally, the volume of data that can be stored in the Global RAM 104 is larger than the volume of data that can be stored in the Local RAM 102.

The input/output IF 105 receives incoming data from the sensor 3, and outputs data received from a different constituent element (e.g., the core 101), to the actuator 4.

The communication IF 106, which is connected to the network 2, enables each constituent element (e.g., the core 101) to refer to data the communication IF 106 receives from the network 2, and transmits data received from each constituent element (e.g., the core 101), to the network 2.

The nonvolatile memory 107 is a storage element that can keep data even after power supply is cut off. The nonvolatile memory 107 holds a software state before cutoff of power supply, and saves an initial value and a fixed value of a control instruction value to each vehicle.

The in-vehicle control device 10 acquires a value detected by the sensor 3 through the input/output IF 105, and puts the acquired value in a state of being accessible to each core (101-0, 101-1, . . . 101-N). The communication IF 106 receives data from the network 2, and puts the received data in a state of being accessible to each core (101-0, 101-1, . . . 101-N). Receiving these accessible data as input data, each core (101-0, 101-1, . . . 101-N) executes a process.

Each core (101-0, 101-1, . . . 101-N) executes a program stored in the Local ROM (103-0, 103-1, . . . 103-N), using input data, data stored in the nonvolatile memory 107, data stored in the Local RAM (102-0, 102-1, . . . 102-N), and data stored in the Global RAM 104. Temporary data of which processing is still in progress is stored in the Local RAM (102-0, 102-1, . . . 102-N) or the Global RAM 104. Some process results are stored in the Local RAM (102-0, 102-1, . . . 102-N) or the Global RAM 104, which allows the stored process results to be used by a different core (101-0, 101-1, . . . 101-N) or at execution of the next process. Some process results are outputted from the input/output IF 105 or the communication IF 106, as output data. Some process results are written to the nonvolatile memory 107 and are saved there. Process results written to the nonvolatile memory 107 are kept therein after power supply to the nonvolatile memory 107 is cut off, and are used by each core (101-0, 101-1, . . . 101-N) at the next cycle of power supply to the nonvolatile memory 107.

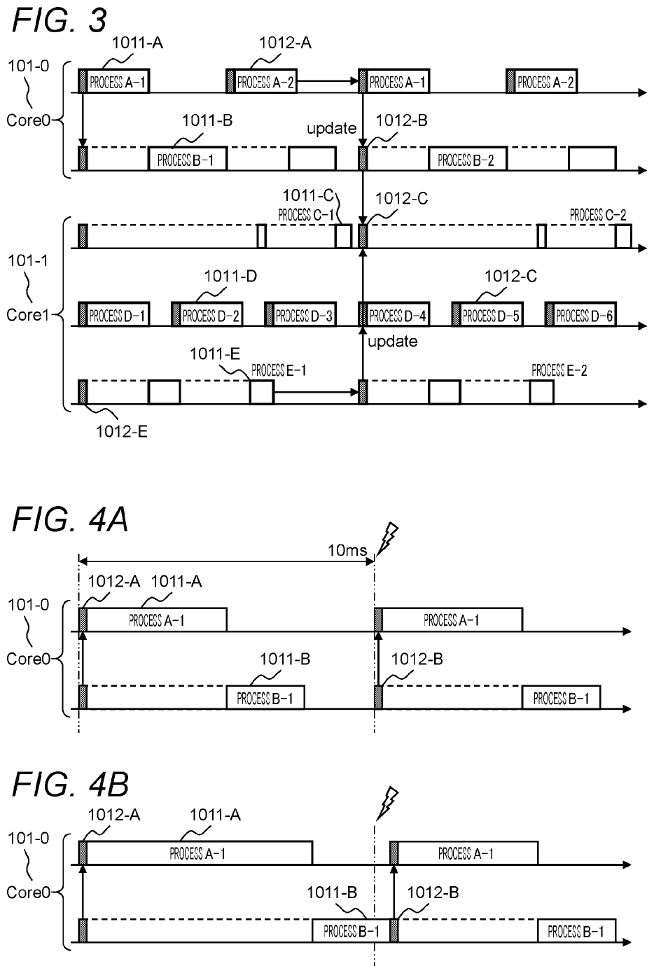

FIG. 3 is a time chart showing an example of execution timing of software according to the first embodiment.

According to this software, each core (101-0, 101-1, . . . 101-N) has an array of process portions (1011-A, 1011-B, . . . 1011-N) and executes each of the process portions (1011-A, 1011-B, . . . 1011-N), as a task. In the example shown in FIG. 3, a core 0 (101-0) has an array of a process portion A (1011-A) and a process portion B (1011-B), and a core 1 has an array of a process portion C (1011-C), a process portion D (1011-D), and a process portion E (1011-E).

At the core 0 (101-0), the process portion A (1011-A) is executed at a 10 ms (milliseconds) cycle, and the process portion B (1011-B) is executed at a 30 ms cycle. Because the process portion B (1011-B) has set priority lower than the set priority of the process portion A (1011-A), the process portion B (1011-B) remains in a standby state or an interruption state during execution of the process portion A (1011-A), and at the end of execution of the process portion A (1011-A), execution of the process portion B (1011-B) is started or restarted.

At the core 1 (101-1), the process portion C (1011-C) is executed at a 30 ms cycle, the process portion D (1011-D) is executed at a 10 ms cycle, and the process portion E (1011-E) is executed at a 30 ms cycle. Because the process portion C (1011-C) has set priority lower than the set priority of the process portion D (1011-D) and the set priority of the process portion E (1011-E), the process portion C (1011-C) remains in a standby state or an interruption state during execution of the process portion D (1011-D) or the process portion E (1011-E), and at the end of execution of the process portion D (1011-D) or the process portion E (1011-E), execution of the process portion C (1011-C) is started or restarted. Likewise, because the process portion E (1011-E) has set priority lower than the set priority of the process portion D (1011-D), the process portion E (1011-E) remains in a standby state or an interruption state during execution of the process portion D (1011-D), and at the end of execution of the process portion D (1011-D), execution of the process portion E (1011-E) is started or restarted.

In this embodiment, each process portion (1011) includes a data synchronization portion (1012). The data synchronization portion (1012) is started at timing set on each process portion (1011) (e.g., at every given cycle). During execution of the data synchronization portion (1012), data is exchanged between the process portions (1011).

When the process portion (1011) outputs its calculation result to a different process portion (1011), the data synchronization portion (1012) writes calculation result data to a shared data storage provided in the Global RAM 104 or the Local ROM 103 so that the different process portion (1011) can refer to the data.

When the process portion (1011) acquires a calculation result of a different process portion (1011) and uses the acquired calculation result as input data, the data synchronization portion (1012) reads necessary data from the above shared data storage.

The process portion (1011) starts its operation after the data synchronization portion (1012) included therein completes input data acquisition.

The data synchronization portion (1012) may be implemented as an input portion and an output portion separate from each other. In this case, the input portion is started at every execution cycle of the process portion (1011), while the output portion is started after the passage of a LET shorter than the execution cycle set on the process portion (1011).

Data exchange between the process portions (1011) is carried out only through the data synchronization portion (1012). As a result, regardless of execution times of the process portions (1011), the data synchronization portion (1012) operates for a constant execution time. For example, when the process portion B (1011-B) operates at a 30 ms cycle, an interval between an input process of the data synchronization portion (1012) and an output process at the next cycle of the data synchronization portion (1012) is 30 ms. The execution time of the data synchronization portion (1012) is a constant time of 30 ms, regardless of the presence/absence of a different process portion with high priority in the current cycle or the size of the execution time of the process portion B (1011-B) itself. In this case, 30 ms is equivalent to a logical execution time (LET) of the process portion B (1011-B).

The logical execution time (LET) is a concept of considering a time a certain process or calculation takes to be constant one to obtain a stable control result. Complicated calculation formulae makes calculation time estimation difficult, which raises a possibility that a control system, in which a passage time from data input to data output is important, becomes incapable of carrying out stable control. A constant calculation time, in contrast, makes an output result effect analysis easy, thus allowing more stable system designing. By observing the LET set for each process, stable control can be implemented even in a complicated system in which a plurality of controls are executed simultaneously. The LET can be expressed as an absolute time or a relative time represented by an integer, a floating point, and the like.

FIGS. 4A and 4B each show an example of a problem to be solved by the present invention that occurs at a control system in which an LET is set.

In the examples shown in FIGS. 4A and 4B, at the core 0 (101-0), the process portion A (1011-A) and the process portion B (1011-B) operate at the same cycle of, for example, 10 ms cycle. Because the process portion B (1011-B) has set priority lower than the set priority of the process portion A (1011-A), the process portion B (1011-B) remains in a standby state or an interruption state during execution of the process portion A (1011-A), and at the end of execution of the process portion A (1011-A), execution of the process portion B (1011-B) is started or restarted.

In FIG. 4A, the core 0 (101-0) is not in a high-load state in the execution time of the process portion A (1011-A), and the process portion B (1011-B) having ended its standby state completes calculations within a 10 ms timespan. The LET starting from the data exchange portion (1012-B), i.e., data synchronization portion (1012-B) is thus observed.

In FIG. 4B, the core 0 (101-0) is in the high-load state during the execution of the process portion A (1011-A). In this case, the end of execution of the process portion A (1011-A) is delayed and therefore the start of execution of the process portion B (1011-B) is delayed. As a result, the process portion B (1011-B) fails to observe the LET ranging from the start of the data synchronization portion (1012-B) to the end of the same.

This case, when the process portion A (1011-A) and the process portion B (1011-B) are independent of each other, results in breach of the LET even if there is no problem with the process portion B (1011-B). Breach of the LET results in, for example, sequential delays in processes at subsequent stages or interruption of the process involving the LET breach, in which case the data exchange portion (1012) at the next cycle uses values in the cycle prior to the interruption for execution of the interrupted process.

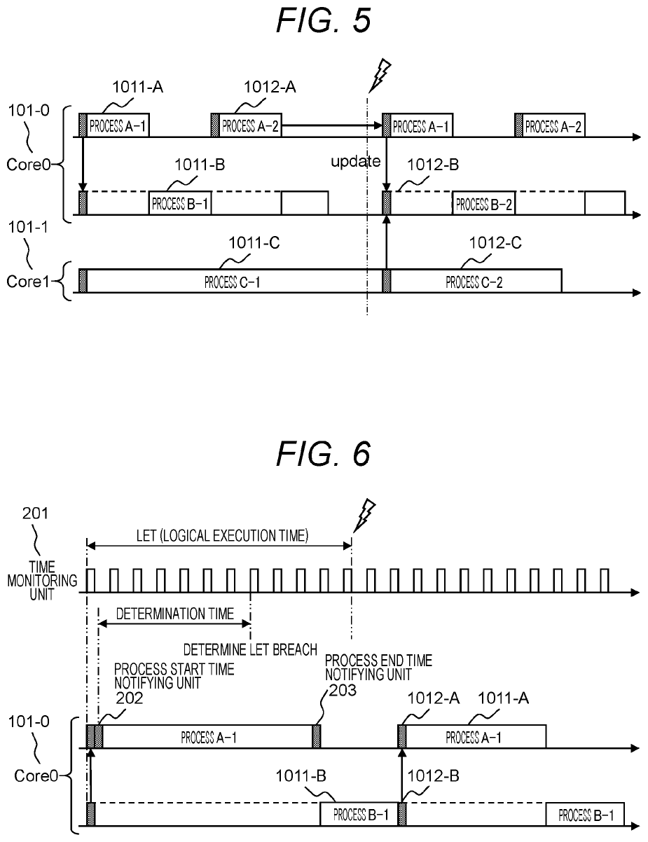

FIG. 5 shows an example of another problem to be solved by the present invention that occurs at a multi-core control system in which an LET is set.

In the example shown in FIG. 5, the core 0 (101-0) has an array of the process portion A (1011-A) that operates at a cycle of 10 ms and that has a set LET of 10 ms and the process portion B (1011-B) that operates at a cycle of 20 ms and that has a set LET of 20 ms. The process portion B (1011-B) has set priority lower than that of the process portion A (1011-A).

The core 1 (101-1) has the process portion C (1011-C) that operates at a cycle of 20 ms and that has a set LET of 20 ms.

In this example, the core 1 (101-1) becomes a high-load state during execution of the process portion C (1011-C) and consequently the process portion C (1011-C) operates for a time longer than the 20 ms LET. As a result, the end of execution of the process portion C (1011-C) is delayed and therefore the start of the data exchange portion (1012-C) of the process portion C is delayed. In this situation, the data exchange portion (1012-A) of the process portion A (1011-A) and the data exchange portion (1011-B) of the process portion B (1012-B) are started in synchronization with the start of the data exchange portion (1012-C) of the process portion C in order to receive data from the process portion C (1011-C). In this example, because the start of execution of the process portion C (1011-C) in the next cycle is delayed under the influence of the high-load state of the core 1 in which execution of the process portion C (1011-C) is in progress, the execution time of each process portion (1011) of the core 0 (101-0) becomes shorter than the ordinary execution time in order to meet a requirement that the LET be observed.

To solve such a problem, according to this embodiment, the execution time is monitored and a sign of a high-load state is detected. This allows implementation of a preliminary measure by which excess over the LET is prevented.

FIG. 6 depicts an execution time monitoring method according to the first embodiment.

In FIG. 6, a time monitoring unit 201 monitors the execution time of the process portion 1011 at a given cycle or constantly. For execution time monitoring, each process portion (1011) includes a process start time notifying unit 202 and an end time notifying unit 203. The process start time notifying unit 202 is executed at the start of the process, and the end time notifying unit 203 is executed at the end of the process.

At the start of the process, the process portion A (1011-A) sends a notification of a process start time, from the process start time notifying unit 202. The process start time is expressed, using an integer or a decimal, as the current time, a passage time from the start of the system, or a passage time from the start of the cycle. The time monitoring unit 201 calculates a passage time from the start of execution of the process, based on a process start time notification sent from the process start time notifying unit 202. The passage time is expressed, using an integer or a decimal, as a passage time from the start of the system, a passage time from the start of the cycle, or a passage time from the start of the process.

The time monitoring unit 201 determines whether a passage time from the start of execution of each process portion (1011) exceeds an excess risk determination time set for each process portion (1011). The excess risk determination time is expressed, using an integer or a decimal, as a passage time from the start of the cycle or a passage time from the start of the process.

As described above, according to the first embodiment, when it is determined that the passage time does not exceed the excess risk determination time, the time monitoring unit 201 ends its processing without doing anything in particular, and stands by or stop operating until the next cycle of execution. When it is determined that the passage time has exceeded the excess risk determination time, on the other hand, a preset substitution means can be implemented. As described later, the substitution means is a simple process by which a result that can substitute the process portion A (1011-A) can be derived in a short time. For example, such a result may be produced by a simple computation process with less input data, or may be outputted simply as a substitution value as a constant.

### Second Embodiment

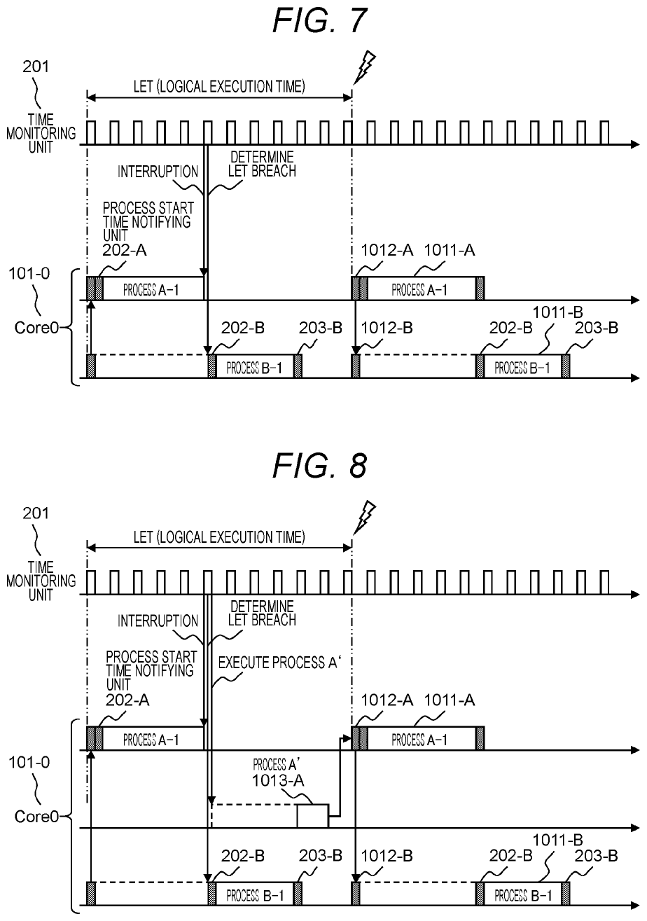

FIG. 7 depicts an execution time monitoring method according to a second embodiment. In the description of the second embodiment, its difference with the first embodiment will mainly be explained, and the same constituent elements and functions as described in the first embodiment will be denoted by the same reference signs and be omitted in further description.

In the second embodiment, the time monitoring unit 201 has a function of issuing an interruption instruction and a start instruction to each process portion 1011. The process start time notifying unit 202 has a function of starting the process according to a start instruction from the time monitoring unit 201. Thus, even if a certain process portion 1011 is delayed in execution due to its high-load state, the process can be started without waiting the end of a different process portion 1011 affected by the delay, which end will be breach of the LET.

According to this embodiment, first, the data exchange portion 1012 starts and collects input data necessary for execution of the process portion 1011. Subsequently, the process start time notifying unit 202 of the process portion A (1011-A) notifies the time monitoring unit 201 of an execution start time. After notifying the execution start time, the process portion A (1011-A) starts the process. Because the process portion B (1011-B) has priority lower than that of the process portion A (1011-A), the process portion B (1011-B) and its execution start time notifying unit (202-B) are in a standby state.

The time monitoring unit 201 compares the process start time imparted by the process portion A with the current time, and determines whether a passage time from the process start time has exceeded an excess risk determination time set on the process portion A (1011-A).

When determining that the passage time has exceeded the excess risk determination time set on the process portion A (1011-A), the time monitoring unit 201 sends an interruption instruction to the process portion A (1011-A) while sending a start instruction to the process portion B (1011-B).

Upon receiving the interruption instruction, the process portion A (1011-A) suspends or stops execution of the process. Upon receiving the start instruction, the process portion B (1011-B) starts its process start time notifying unit (202-B) and notifies the time monitoring unit 201 of a process start time.

Similarly to the above, for the case of the process portion B, the time monitoring unit 201 determines whether its passage time from the process start time has exceeded the excess risk determination time. In FIG. 7, the process portion B (1011-B) is not in a high-load state and therefore execution of the process portion B (1011-B) ends within the excess risk determination time. The end time notifying unit (1011-B) of the process portion B (203-B) thus notifies the time monitoring unit 201 of the process end time. The time monitoring unit 201 then ends execution time monitoring on the process portion B (1011-B) whose process end time has been imparted to the time monitoring unit 201.

As described above, according to the second embodiment, the process start time notifying unit 202 notifies the time monitoring unit 201 of the process start time. This allows monitoring to determine whether a time each process portion (1011) takes for calculations exceeds the excess risk determination time. The time monitoring unit 201 sends an interruption instruction and a start instruction to suspend or stop execution of a process portion 1011 in a high-load state while starting execution of a different process portion 1011. Hence breach of the LET caused by the influence of the high-load state can be prevented.

In addition, because the end time notifying unit 203 notifies the time monitoring unit 201 of the process end time, the time monitoring unit 201 is prevented from making an erroneous interruption of the process.

### Third Embodiment

FIG. 8 depicts an execution time monitoring method according to a third embodiment.

The third embodiment is different from the second embodiment in that a substitution process portion 1013 is started after the process portion 1011 is interrupted by the time monitoring unit 201. In the description of the third embodiment, its difference with the second embodiment will mainly be explained, and the same constituent elements and functions as described in the second embodiment will be denoted by the same reference signs and be omitted in further description.

According to this embodiment, in addition to the software configuration of the second embodiment, the control device further includes a substitution process portion A′ (1013-A) substituting for the process portion A (1011-A). The substitution process portion A′ (1013-A) is a simple process by which a result that can be used as a substitution for the process portion A (1011-A) is derived in a short time. For example, such a result may be produced by a simple computation process with less input data, or may be outputted simply as a substitution value as a constant.

According to this embodiment, after determining that the processing time of the process portion A (1011-A) has exceeded the excess risk determination time, the time monitoring unit 201 sends an interruption instruction and a start instruction respectively to the process portion A (1011-A) and the process portion B (1011-B) in the same manner as in the second embodiment. In this embodiment, a start instruction is sent to the substitution process portion A′ (1013-A) at this point of time. Timing of sending the start instruction to the substitution process portion A′ (1013-A) and timing of sending the interruption instruction to the process portion A (1011-A) can be selected arbitrarily, providing that the substitution process portion A′ (1013-A) is started after interruption of the process portion A (1011-A). Because the substitution process portion A′ (1013-A) has priority lower than that of the process portion B (1011-B), the substitution process portion A′ (1013-A) is executed after the end of the process portion B (1011-B).

The substitution process portion A′ (1013-A) receives data from the data exchange portion (1012-A) of the process portion A (1011-A). After being started, therefore, the substitution process portion A′ (1013-A) executes the process using the data t receiving from the data exchange portion (1012-A). A process result from the substitution process portion A′ (1013-A) is outputted by the data exchange portion (1011-A) in the next cycle, to a different process portion.

As described above, according to the third embodiment, even if the process portion 1011 is interrupted because of its a high-load state, the substitution process portion 1013 can be started in a free time slot after the end of a process portion 1011 with higher priority. By the substitution process portion 1013, therefore, at least calculation of continuous values that requires a time slot extending over multiple cycles can be maintained as the LET of a different process portion 1011 is observed.

### Fourth Embodiment

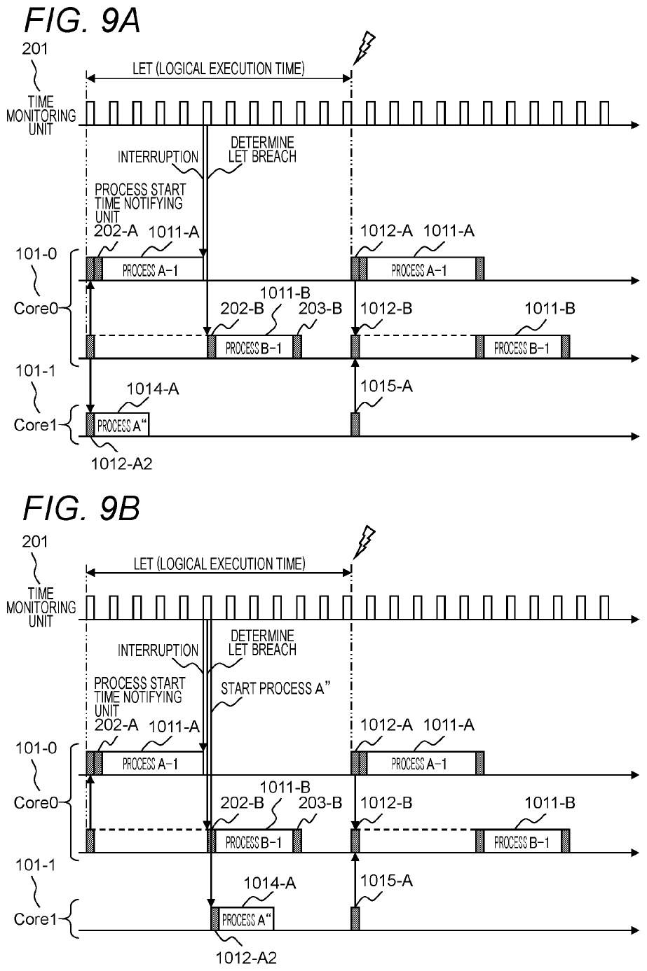

FIGS. 9A and 9B each depicts an execution time monitoring method according to a fourth embodiment.

The fourth embodiment is different from the third embodiment in that a parallel process portion 1014 is additionally provided in place of the substitution process portion 1013. In the description of the fourth embodiment, its difference with the third embodiment will mainly be explained, and the same constituent elements and functions as described in the third embodiment will be denoted by the same reference signs and be omitted in further description.

In this embodiment, as in the third embodiment, the core 0 (101-0) has an array of the process portion A (1011-A) and the process portion B (1011-B) and the core 1 (101-1) has a parallel process portion A (1014-A). The parallel process portion 1014, which is a substitution process for the corresponding process portion 1011, is always executed simultaneously with the process portion 1011.

In FIG. 9A, a parallel process portion A″ (1014-A), which is executed in the same cycle of execution of the process portion A (1011-A), includes a data exchange portion 1012-A2, which starts at the start of the cycle in the same manner as the data exchange portion (1012-A) of the process portion A (1011-A) does, and acquires the same data as input data to the process portion A (1011-A). Subsequently, the parallel process portion A″ (1014-A) starts and executes the process.

Because the process portion B (1011-B) uses a calculation result from the process portion A (1011-A), the data exchange portion (1012-B) of a process portion B (1012-B) acquires output data from the data exchange portion (1012-A) of the process portion A (1011-A). In the example shown in FIG. 9A, because the execution time of the process portion A (1011-A) has exceeded the excess risk determination time, the process portion A (1011-A) receives an interruption instruction from the time monitoring unit 201 and is interrupted.

At this time, the data exchange portion (1012-B) of the process portion B (1011-B) switches a data acquisition destination, from the data exchange portion (1012-A) of the process portion A (1011-A) to the data exchange portion (1012-A2) of the parallel process portion A″ (1014-A).

In a modification of the fourth embodiment shown in FIG. 9B, the parallel process portion A″ (1014-A), which is a substitution process for the corresponding process portion 1011, is executed simultaneously with the process portion B (1011-B). The parallel process portion A″ (1014-A) includes the data exchange portion 1012-A2, which starts at the start of the cycle in the same manner as the data exchange portion (1012-A) of the process portion A (1011-A) does, and acquires the same data as input data to the process portion A (1011-A). Because the process portion B (1011-B) uses a calculation result from the process portion A (1011-A), the data exchange portion (1012-B) of a process portion B (1011-B) acquires output data from the data exchange portion (1012-A) of the process portion A (1011-A).

In the example shown in FIG. 9B, because the execution time of the process portion A (1011-A) has exceeded the excess risk determination time, the time monitoring unit 201 sends an interruption instruction to the process portion A (1011-A). Receiving the interruption instruction from the time monitoring unit 201, the process portion A (1011-A) is interrupted. The time monitoring unit 201 then sends a start instruction to the process portion B (1011-B). Receiving the start instruction from the time monitoring unit 201, the process portion B (1011-B) starts its process. The time monitoring unit 201 sends a start instruction also to the parallel process portion A″ (1014-A). Receiving the start instruction from the time monitoring unit 201, the process portion A″ (1014-A) starts its process. The process portion A″ (1014-A) may start its process autonomously at the end of the excess risk determination time or may start the process according to the same start instruction as the start instruction sent to the process portion B (1011-B).

At this time, to maintain calculation of continuous values, the data exchange portion (1012-B) of the process portion B (1011-B) uses a calculation result produced by the process portion A (1011-A) in the previous cycle.

The time monitoring unit 201 starts the parallel process portion A″ (1014-A) at a point of time at which the time monitoring unit 201 sends an interruption instruction to the process portion A (1011-A) whose processing time has exceeded the excess risk determination time.

As described above, according to the fourth embodiment, even if the process portion 1011 is interrupted by the time monitoring unit 201 because of the high-load state of the process portion 1011, using a calculation result from the parallel process portion 1014 allows at least maintaining calculation of continuous values that requires a time slot extending over multiple cycles. In addition, because the parallel process portion 1014 operates in a different core, the calculation can be completed even if the core including the above process portion 1011 becomes a high-load state due to a calculation load of a different process portion 1011.

### Fifth Embodiment

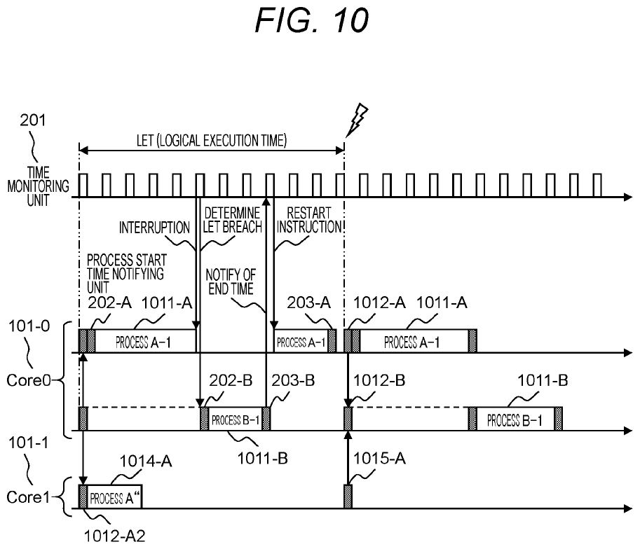

FIG. 10 depicts an execution time monitoring method according to a fifth embodiment.

The fifth embodiment is different from the fourth embodiment in that the time monitoring unit 201 sends a restart instruction and that the data exchange portion 1012 selects data to acquire. In the description of the fifth embodiment, its difference with the fourth embodiment will mainly be explained, and the same constituent elements and functions as described in the fourth embodiment will be denoted by the same reference signs and be omitted in further description.

Arrangement of the process portions 1011 and the operation of the parallel process portion 1014 in this embodiment are the same as those in the fourth embodiment.

In this embodiment, an end time notifying unit (203-B) of the process portion B (1011-B) notifies the time monitoring unit 201 of an end time. When notified of the end time by the end time notifying unit (203-B), the time monitoring unit 201 determines whether the entire process has been completed. When determining that the entire process has been completed, the time monitoring unit 201 sends a restart instruction to the process portion 1011 in an interrupted state. In the example shown in FIG. 10, the time monitoring unit 201 sends a restart instruction to the process portion A (1011-A). Upon receiving the restart instruction, the process portion A (1011-A) restarts its suspended process.

In this embodiment, the process portion A (1011-A) having resumed its process and the parallel process portion A″ (1014-A) complete their calculations within the LET. At this time, both the data exchange portion (1012-A) of the process portion A (1011-A) and the data exchange portion (1012-A2) of the parallel process portion (1014-A) can transmit calculation results to the data exchange portion (1012-B) of the process portion B (1011-B). At this point, the data exchange portion (1012-B) of the process portion B (1011-B) needs to select data to acquire.

At this time, the data exchange portion (1012-B) of the process portion B (1011-B) selects data to acquire, depending on whether an end time notifying unit (203-A) of the process portion A (1011-A) has notified of an end time. When the end time notifying unit (203-A) has notified of the end time, the data exchange portion (1012-B) of the process portion B (1011-B) acquires a calculation result from the data exchange portion (1012-A) of the process portion A (1011-A). When the end time notifying unit (203-A) has not notified of the end time, on the other hand, the data exchange portion (1012-B) of the process portion B (1011-B) acquires a calculation result from the data exchange portion (1012-A2) of the parallel process portion A″ (1014-A).

As described above, according to the fifth embodiment, the data exchange portion 1012 can select either acquisition of a calculation result from the process portion 1011, i.e., normal process portion, or acquisition of a calculation result from the substitution process portion 1013 or the parallel process portion 1014, depending on whether the end time notifying unit 203 has notified of the end time. Even if the process portion 1011 is interrupted once because of its high-load state, therefore, the result of the process resumed after the interruption can be acquired. Hence calculation of continuous values that requires a time slot extending over multiple cycles can be maintained as the LET of a different process is observed.

### Sixth Embodiment

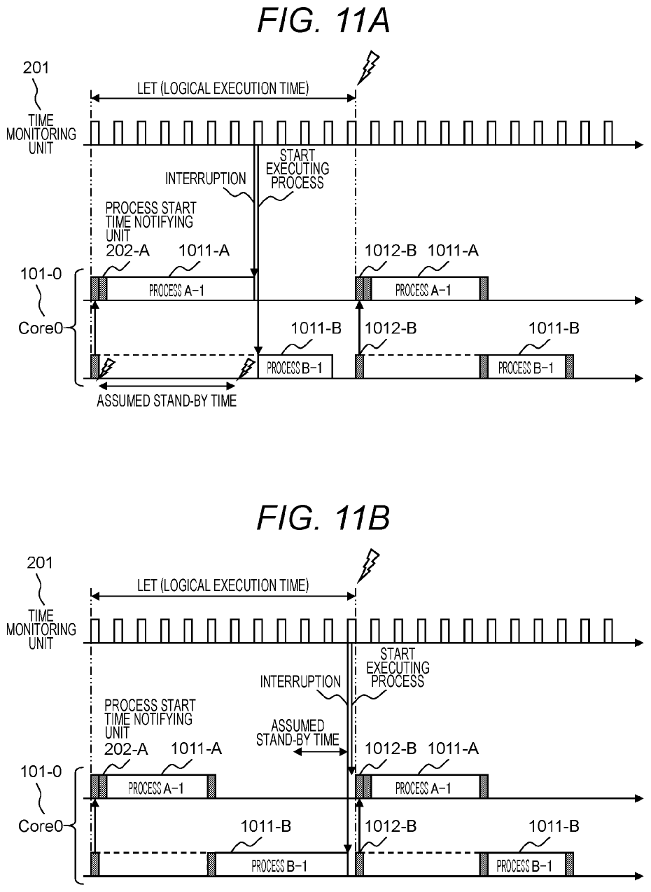

FIGS. 11A and 11B each depict an execution time monitoring method according to a sixth embodiment.

The sixth embodiment is different from the second embodiment in that the time monitoring unit 201 determines excess of the execution time of the process portion A by referring to the assumed standby time of the process portion B. In the description of the sixth embodiment, its difference with the second embodiment will mainly be explained, and the same constituent elements and functions as described in the second embodiment will be denoted by the same reference signs and be omitted in further description.

In the examples shown in FIGS. 11A and 11B, the core 0 (101-0) has an array of the process portion A (1011-A) and the process portion B (1011-B), which operate at the same cycle, as in the example of FIG. 7. Because the process portion A (1011-A) has priority higher than that of the process portion B (1011-B), the process portion B (1011-B) stands by until the process portion A (1011-A) ends its calculation.

In this embodiment, an assumed standby time is set for each process portion 1011. The assumed standby time is a minimum-necessary standby time that allows the process portion 1011 to observe the LET after starting operating. The assumed standby time is time information expressed as an integer or a decimal, such as a relative time or an absolute time or a standby time elapsed from the start of the cycle.

Each data exchange portion 1012 notifies of a cycle start time at execution of the process cycle. The time monitoring unit 201 calculates a passage time from the cycle start time. When determining that the assumed standby time has passed, the time monitoring unit 201, to start the process portion 1011 having the assumed standby time set therefor, sends an interruption instruction to a different process portion.

FIG. 11 A shows a situation in which the process portion A (1011-A) has become a high-load state and is about to be executed in a time slot exceeding the assumed standby time of the process portion B (1011-B). At this time, the time monitoring unit 201 does not receive a notification of process start time from the process portion B (1011-B), and therefore determines that the execution time of the process portion A (1011-A) does not exceed the assumed standby time of the process portion B (1011-B). When detecting the execution time of the process portion A (1011-A) exceeding the assumed standby time of the process portion B (1011-B), the time monitoring unit 201 sends an interruption instruction to the process portion A (1011-A). When receiving the interruption instruction, the process portion A (1011-A) suspends its process or becomes a standby state. The time monitoring unit 201 sends an execution start instruction to the process portion B (1011-B). When receiving the execution start instruction, the process portion B (1011-B) starts its process when a different process portion 1011 is not started.

As shown in FIG. 11B, the assumed standby time may be defined for the process portion A (1011-A). FIG. 11B shows a situation in which the process portion B (1011-B) has become a high-load state and is about to be executed in a time slot exceeding the assumed standby time of the process portion A (1011-A). At this time, the time monitoring unit 201 does not receive a notification of process start time from the process portion A (1011-A), and therefore determines that the execution time of the process portion B (1011-B) does not exceed the assumed standby time of the process portion A (1011-A). When detecting the execution time of the process portion B (1011-B) exceeding the assumed standby time of the process portion A (1011-A), the time monitoring unit 201 sends an interruption instruction to the process portion B (1011-B). When receiving the interruption instruction, the process portion B (1011-B) suspends its process or becomes a standby state. The time monitoring unit 201 sends an execution start instruction to the process portion A (1011-A). When receiving the execution start instruction, the process portion A (1011-A) starts its process when a different process portion 1011 is not started.

As described above, according to the sixth embodiment, the assumed standby time is defined for each process portion (1011), and based on this assumed standby time, the time monitoring unit 201 gives an instruction to execute the process. This allows each process portion to finish its calculation within an estimated execution time. According to this embodiment, for example, when a plurality of process portions created by a designer are integrated together, the LET can be observed by suppressing influences from other process portions.

### Seventh Embodiment

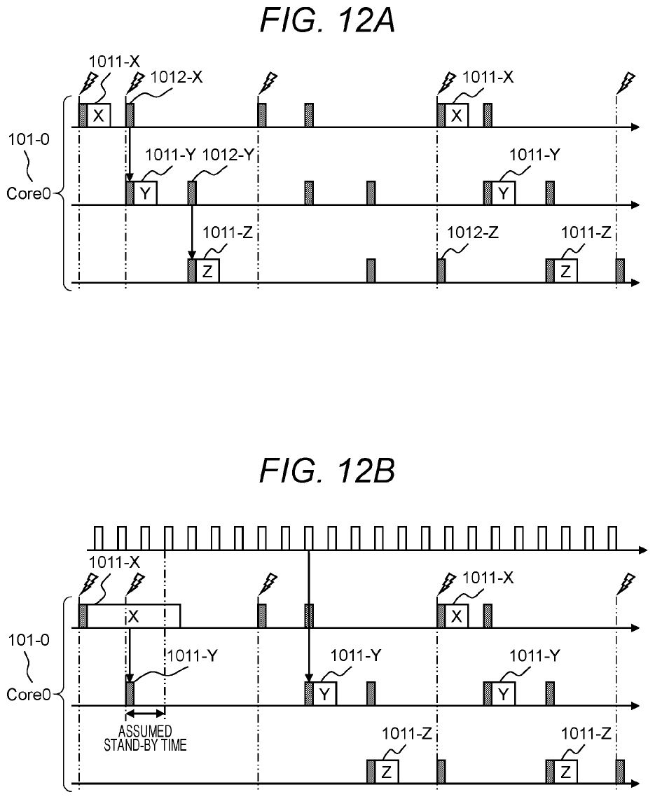

FIGS. 12A and 12B each depict an execution time monitoring method according to a seventh embodiment.

The seventh embodiment is different from the second embodiment in that the process portion 1011 has substitution timing for starting a plurality of times within the cycle, in addition to a start cycle. In the description of the seventh embodiment, its difference with the second embodiment will mainly be explained, and the same constituent elements and functions as described in the second embodiment will be denoted by the same reference signs and be omitted in further description.

In FIG. 12A, the core 0 (101-0). has an array of a process portion X (1011-X), a process portion Y (1011-Y), and a process portion Z (1011-Z). The three process portions each start at the same cycle of 20 ms, and the process portion Y (1011-Y) has an offset time of 3 ms and the process portion Z (1011-Z) has an offset time of 6 ms. The offset time in this embodiment refers to a time to take from the start of the process cycle to the actual start of the process.

The process portions 1011 have different LETs that are defined therefor, respectively. For example, the LET of the process portion X (1011-X) is 3 ms, the LET of the process portion Y (1011-Y) is 3 ms, and the LET of the process portion Z (1011-Z) is 4 ms. The total of the LETs of the process portions (1011-X, 1011-Y, 1011-Z) is therefore 10 ms, which is shorter than the execution cycle of 20 ms. When all process portions (1011-X, 1011-Y, 1011-Z) end their operations normally, it leaves a grace period of 10 ms before the next process portion 1011 starts.

In this embodiment, substitution timing is set so that the data exchange portion 1012 starts not only at the 20 ms cycle, which is the original cycle, but also at the 10 ms cycle, which is a point of time within the original 20 ms cycle.

FIG. 12B shows respective operations of the process portions in a case where the process portion X (1011-X) becomes a high-load state and its execution time exceeds the LET of 3 ms. When the execution time of the process portion X (1011-X) exceeds the LET, the data exchange portion (1011-Y) of the process portion Y (1011-Y) starts during execution of the process portion X (1011-X) and detects that the process portion X (1011-X) is not ended. After detecting the process portion X (1011-X) being not ended, the data exchange portion (1011-Y) stops the process portion Y (1011-Y) from starting at the original cycle. Meanwhile, being unable to acquire a calculation result from the process portion Y (1011-Y), the data exchange portion (1012-Z) of the process portion Z (1011-Z) stops its start.

Operations the data exchange portion 1012 carries out at the substitution timing are as follows.

According to this embodiment, at the substitution timing, the data exchange portion (1012-X) of the process portion X (1011-X) does not operate because the calculation by the process portion X (1011-X) in the normal cycle is completed.

At the substitution timing, the data exchange portion (1012-Y) of the process portion Y (1011-Y) starts because the calculation by the process portion Y (1011-Y) in the normal cycle is stopped. The data exchange portion (1012-Y) of the process portion Y (1011-Y), the data exchange portion (1012-Y) having started at the substitution timing, acquires a calculation result by the process portion X (1011-X) from the data exchange portion (1012-X), as does in the case of starting at the normal cycle. When the calculation is over, the data exchange portion (1012-Y) is able to provide a calculation result by the process portion Y (1011-Y) to a different process portion 1011 after the passage of the LET of the process portion Y (1011-Y).

At the substitution timing, the data exchange portion (1012-Z) starts because the data exchange portion (1012-Z) of the process portion Z (1011-Z) has stopped the calculation in the normal cycle and calculation by the process portion Y (1011-Y) at the substitution timing has ended within the LET. The data exchange portion (1012-Z) of the process portion Z (1011-Z), the data exchange portion (1012-Z) having started at the substitution timing, acquires a calculation result by the process portion Y (1011-Y) from the data exchange portion (1012-Y), as does in the case of starting at the normal cycle. When the calculation is over, the data exchange portion (1012-Z) is able to provide a calculation result by the process portion Z (1011-Z) to a different process portion 1011 after the passage of the LET of the process portion Z (1011-Z).

An increase in the execution time of the process portion 1011 may result not only from execution of the process portion 1011 itself but also from execution of a process with higher priority and a shorter execution cycle. In addition to that, a process started at the point of reception of data from the sensor 3 or communication data, such as an interruption process, may also be involved, in which case estimating a processing load in advance is difficult.

According to the seventh embodiment, because each process portion 1011 starts at substitution timing set therefor, even if a process at the preceding stage executes its calculation in a time slot exceeding the LET, the overall calculation ends within the cycle to observe the overall LET when, in particular, a plurality of the process portions 1011 are arranged in a time-sequence relation in the same cycle. Timing of the inputting/outputting calculation results from the process portion 1011 is thus fixed to the LET. This reduces a possibility that control results turn out to be unexpected one.

### Eighth Embodiment

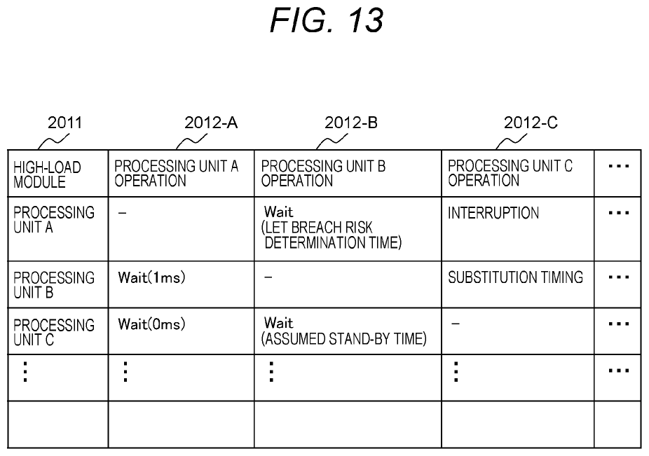

FIG. 13 depicts a standby time selection table the time monitoring unit 201 of an eighth embodiment has.

The eighth embodiment is different from the second, sixth, and seventh embodiments in that a monitoring time of the time monitoring unit 201 and the start of a substitution process by an instruction from the time monitoring unit 201 are controlled for each process portion. In the description of the eighth embodiment, its difference with the second, sixth, and seventh embodiments will mainly be explained, and the same constituent elements and functions as described in those embodiments will be denoted by the same reference signs and be omitted in further description.

The standby time selection table holds, for each process portion 1011, a standby time of the process portion 1011 execution of which is affected by the high-load state of the process portion 1011. In a high-load module column 2011, information for uniquely identifying each process portion 1011 is entered. For example, a unique value is entered in the form of a combination of integers, character strings, or bit patterns. A process portion operation definition column 2012 has the same number of entries as the number of process portions 1011. In each of rows making up the process portion operation definition column 2012, information on the operation of the process portion 1011, such as waiting for a certain period of time or executing the process at substitution timing or suspending the process, is entered. Operation information entries are not limited to the entries mentioned above.

When the operation of the process portion is “waiting for a certain period of time”, time information, such as a fixed time of 1 ms or so, an excess risk determination time of a high-load module, and an assumed standby time held by the process portion 1011 indicated by the process portion operation definition column 2012, is entered. Time information entries are not limited to the entries mentioned above.

Hereinafter, a process portion operation definition column (2012-A) on the process portion A (1011-A) in the standby time selection table of FIG. 13 will be described.

No value is entered in the row corresponding to the process portion A (1011-A) in the high-load module column 2011. This is because that an operation, such as standby or interruption, is not defined for the process portion 1011 in a high-load state.

A value indicating “waiting for 1 ms” is entered in the row corresponding to the process portion B (1011-B) in the high-load module column 2011. This value defined in the table means that as a result of the process portion B (1011-B) having become a high-load state and the LET time having passed, the data exchange portion (1012-A) of the process portion A (1011-A) waits for 1 ms before its start. The time monitoring unit 201 calculates a passage time from the start of the cycle, and determines whether the process portion A (1011-A) has waited for 1 ms or more. When determining that the process portion A (1011-A) has waited for 1 ms or more, the time monitoring unit 201 sends an interruption instruction to the process portion B (1011-B).

A value indicating “waiting for 0 ms” is entered in the row corresponding to the process portion C (1011-C) in the high-load module column 2011. This value defined in the table means that as a result of the process portion C (1011-C) having become a high-load state and the LET time having passed, the data exchange portion (1012-A) of the process portion A (1011-A) starts without waiting any second. The time monitoring unit 201 monitors the execution time of the control device 1 and determines whether the start cycle of the process portion A (1011-A) has arrived. When determining that the start cycle of the process portion A (1011-A) has arrived, the time monitoring unit 201 sends an interruption instruction to the process portion B (1011-B).

Hereinafter, a process portion operation definition column (2012-B) on the process portion B (1011-B) in the standby time selection table of FIG. 13 will be described.

A value indicating “waiting for the excess risk determination time” is entered in the row corresponding to the process portion A (1011-A) in the high-load module column 2011. This value defined in the table means that as a result of the process portion A (1011-A) having become a high-load state and the LET time having passed, the data exchange portion (1012-B) of the process portion B (1011-B) waits to refrain from starting until the excess risk determination time of the process portion A (1011-A) passes. As described in the second embodiment, the time monitoring unit 201 calculates a passage time from the start of the cycle, and determines whether the process portion B (1011-B) has waited for a time equal to or longer than the excess risk determination time of the process portion A (1011-A). When determining that the process portion B (1011-B) has waited for a time equal to or longer than the excess risk determination time of the process portion A (1011-A), the time monitoring unit 201 sends an interruption instruction to the process portion A (1011-A).

No value is entered in the row corresponding to the process portion B (1011-B) in the high-load module column 2011. This is because that an operation, such as standby or interruption, is not defined for the process portion 1011 in a high-load state.

A value indicating “waiting for the assumed standby time” is entered in the row corresponding to the process portion C (1011-C) in the high-load module column 2011. This value defined in the table means that as a result of the process portion A (1011-A) having become a high-load state and the LET time having passed, the data exchange portion (1012-B) of the process portion B (1011-B) waits to refrain from starting until the assumed standby time of the process portion A (1011-A) passes. As described in the sixth embodiment, the time monitoring unit 201 calculates a passage time from the start of the cycle, and determines whether the process portion B (1011-B) has waited for a time equal to or longer than the assumed standby time of the process portion A (1011-A). When determining that the process portion B (1011-B) has waited for a time equal to or longer than the assumed standby time of the process portion A (1011-A), the time monitoring unit 201 sends an interruption instruction to the process portion A (1011-A).

Hereinafter, a process portion operation definition column (2012-C) on the process portion C (1011-C) in the standby time selection table of FIG. 13 will be described.

A value indicating “interruption” is entered in the row corresponding to the process portion A (1011-A) in the high-load module column 2011. This value defined in the table means that as a result of the process portion A (1011-A) having become a high-load state and the LET time having passed, the data exchange portion (1012-C) of the process portion C (1011-C) does not execute the process in the cycle.

“Substitution timing” is entered in the row corresponding to the process portion B (1011-B) in the high-load module column 2011. This value defined in the table means that as a result of the process portion A (1011-B) having become a high-load state and the LET time having passed, the data exchange portion (1012-C) of the process portion C (1011-C) abandons execution of the process in the cycle and tries restarting at substitution timing, as described in the seventh embodiment.

No value is entered in the row corresponding to the process portion C (1011-C) in the high-load module column 2011. This is because that an operation, such as standby or interruption, is not defined for the process portion 1011 in a high-load state.

In a case where each process portion is developed by a different person, the priority of each process portion (1011) may remain unknown until the process portions are put together and are installed in one control device 1. By referring to the standby time selection table, design information, such as an assumed standby time and an excess risk determination time of each process portion (1011) and an allowable standby time of the control device as a whole, can be selected and incorporated in actual design work. Hence the priority of the process portion corresponding to the configuration of the control device 1 can be set. In addition, by determining the operation of each process portion in response to the presence of a high-load module, the above-described embodiments can be applied in a mixed manner to one control device.

The present invention is not limited to the above embodiments, and includes various modifications and configurations equivalent thereto, which are within the scope of the appended claims. For example, the embodiments have been described in detail above in order to facilitate understanding of the present invention. The present invention is, therefore, not necessarily limited to an embodiment including all constituent elements described above. Some constituent elements of a certain embodiment may be replaced with constituent elements of another embodiment. A constituent element of another embodiment may be added to a constituent element of a certain embodiment. Some constituent elements of each embodiment may be deleted, or add to or replaced with constituent elements of another embodiment.

Some or all of the above constituent elements, functions, process portions, process means, and the like may be provided in the form of hardware by packaging them in an integrated circuit, or in the form of software by causing a processor to interpret and execute programs that implement respective functions.

Information on programs, tables, files, and the like for implementing various functions may be stored in a storage device, such as a memory, a hard disk, and a solid state drive (SSD), or in a recording medium, such as an IC card, an SD card, and a DVD.

A group of control lines and data lines considered to be necessary for description are illustrated, and all control lines and information lines needed for configuration are not necessarily illustrated. It is safe to assume that, actually, almost the entire constituent elements are interconnected.

1. A control device including a plurality of cores each having an array of one or more process portions that are started cyclically, the control device comprising:
a first process portion having a given logical execution time set therefor; and
a time monitoring unit that determines an execution state of each of the process portions in a determination time shorter than the logical execution time of the first process portion,
wherein the time monitoring unit determines whether a passage time from start of the first process portion exceeds the determination time.

2. The control device according to claim 1, wherein
when determining that a passage time from start of the first process portion exceeds the determination time, the time monitoring unit outputs an interruption instruction to the first process portion, and
the first process portion interrupts a process according to the interruption instruction.

3. The control device according to claim 2, comprising a second process portion that outputs a result capable of substituting for the first process portion,
wherein the time monitoring unit outputs a start instruction to start the second process portion, and
according to the start instruction, the second process portion starts a process after a process of the first process portion is interrupted.

4. The control device according to claim 2, comprising a third process portion disposed in a core different from a core including the first process portion, the third process portion being executed at a cycle same as a cycle at which the first process portion is executed,
wherein when the first process portion interrupts a process, a process result from the third process portion is used in place of a process result from the first process portion, at a process portion in a subsequent stage.

5. The control device according to claim 2, wherein
when determining that a process of a process portion disposed in a core same as a core including the first process portion has ended, the time monitoring unit outputs a restart instruction to restart the first process portion, and
according to the restart instruction, the first process portion restarts a process.

6. The control device according to claim 5, comprising a third process portion disposed in a core different from a core including the first process portion, the third process portion being executed at a cycle same as a cycle at which the first process portion is executed,
wherein when, after being restarted, the first process portion ends a process within the logical execution time, not a process result from the third process portion but a process result from the first process portion is used at a process portion in a subsequent stage.

7. The control device according to claim 1, comprising a fourth process portion disposed in a core same as a core including the first process portion, the fourth process portion being executed cyclically,
wherein the fourth process portion has a logical execution time and an assumed standby time shorter than the logical execution time, the logical execution time and the assumed standby time being set for the fourth process portion,
the fourth process portion is capable of being started at substitution timing in the assumed standby time starting from an original start cycle, and
the time monitoring unit determines whether a passage time from start of the first process portion exceeds the assumed standby time.

8. The control device according to claim 1, comprising a fourth process portion disposed in a core the same as a core including the first process portion, the fourth process portion capable of being started cyclically and being started at substitution timing different from an original start cycle,
wherein when determining that a passage time from start of the first process portion exceeds the determination time, the time monitoring unit starts the fourth process portion not at the original start cycle but at the substitution timing.

9. The control device according to claim 8, wherein
the time monitoring unit has standby time selection information that determines whether another process portion waits or starts at substitution timing when an execution time of the first process portion gets longer and that determines whether a determination time for waiting is an excess risk determination time or an assumed standby time.

10. A control method for a control device including a plurality of cores each having an array of one or more process portions that are started cyclically,
wherein the control device includes:
a first process portion having a given logical execution time set therefor; and
a time monitoring unit that determines an execution state of each of the process portions, and
the control method comprises:
causing the time monitoring unit to determine whether a passage time from start of the first process portion exceeds a determination time shorter than a logical execution time of the first process portion;
outputting an interruption instruction to the first process portion when the time monitoring unit determines that the passage time from start of the first process portion exceeds the determination time; and
causing the first process portion to interrupt a process according to the interruption instruction.
